(19) United States
(12) Patent Application Publication
(10) Pub. No.: US 2017/0008375 A1
(43) Pub. Date: Jan. 12, 2017

(54) Preconditioning an Electric Vehicle

(71) Applicant: Ford Global Technologies, LLC, Dearborn, MI (US)

(72) Inventors: Timothy Noah BLATCHLEY, Dearborn, MI (US); Angel Fernando PORRAS, Dearborn, MI (US); Mark G. SMITH, Canton, MI (US)

(21) Appl. No.: 14/795,965

(22) Filed: Jul. 10, 2015

(51) Int. Cl. B60H 1/22; H01M 10/633; H01M 10/615; H01M 10/625; B60L 11/18; B60H 1/00

(52) U.S. Cl. CPC B60H 1/2218; B60L 11/1875; B60L 11/1861; B60H 1/00278; H01M 10/615; H01M 10/625; H01M 10/633; B60H 2001/224; B60H 2001/2253; B60H 2001/2262

(57) ABSTRACT

A vehicle includes a traction battery, a cabin, and a controller. The controller is programmed to, in response to a request to heat both the battery and the cabin, and a time to next planned usage of the vehicle exceeding a first threshold time, heat the battery and delay heating the cabin at least until the time to next planned usage is less than the first threshold time.

### TECHNICAL FIELD

The present disclosure relates to a control strategy and method for preconditioning a traction battery and/or a passenger cabin of a motor vehicle.

### BACKGROUND

The need to reduce fuel consumption and emissions in automobiles and other vehicles is well known. Vehicles are being developed that reduce reliance or completely eliminate reliance on internal combustion engines. Electrified vehicles are one type of vehicle currently being developed for this purpose. A major challenge with electric vehicles is increasing the fully-electric range of the vehicle.

### SUMMARY

According to one embodiment, a vehicle includes a traction battery, a cabin, and a controller. The controller is programmed to, in response to a request to heat both the battery and the cabin, and a time to next planned usage of the vehicle exceeding a first threshold time, heat the battery and delay heating the cabin at least until the time to next planned usage is less than the first threshold time.

According to another embodiment, a vehicle includes a battery, a thermal circuit, and a controller. The thermal circuit is arranged to circulate coolant through the battery, a heater, a pump and valving. The controller is programmed to, in response to a request to heat both the battery and a cabin, and a time to next planned usage of the vehicle exceeding a first threshold time, de-energize a cabin blower, energize the pump and the heater, and actuate the valving such that the battery receives heated coolant.

According to yet another embodiment, a method of preconditioning a vehicle is disclosed. The vehicle includes a cabin and a traction battery configured to receive power from a charging station. The method includes receiving a request to heat both the battery and the cabin. The method further includes heating the battery while the vehicle is receiving power from the charging station in response to a time to next planned usage of the vehicle being greater than a first threshold time. The method also includes delaying heating of the cabin at least until the time to next planned usage is less than the first threshold time.

### BRIEF DESCRIPTION OF THE DRAWINGS

FIG. 1 is a schematic diagram of an example hybrid vehicle.

FIG. 2 is a schematic diagram of a battery thermal management system and a climate control system of a vehicle.

FIG. 3 is a schematic diagram of a battery thermal management system and a climate control system of another vehicle.

FIG. 4 is the schematic diagram of FIG. 2 shown in a battery and cabin heating mode.

FIG. 5 is the schematic diagram of FIG. 3 shown in a cabin heating mode.

FIG. 6 is a flow chart illustrating logic for preconditioning a vehicle.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

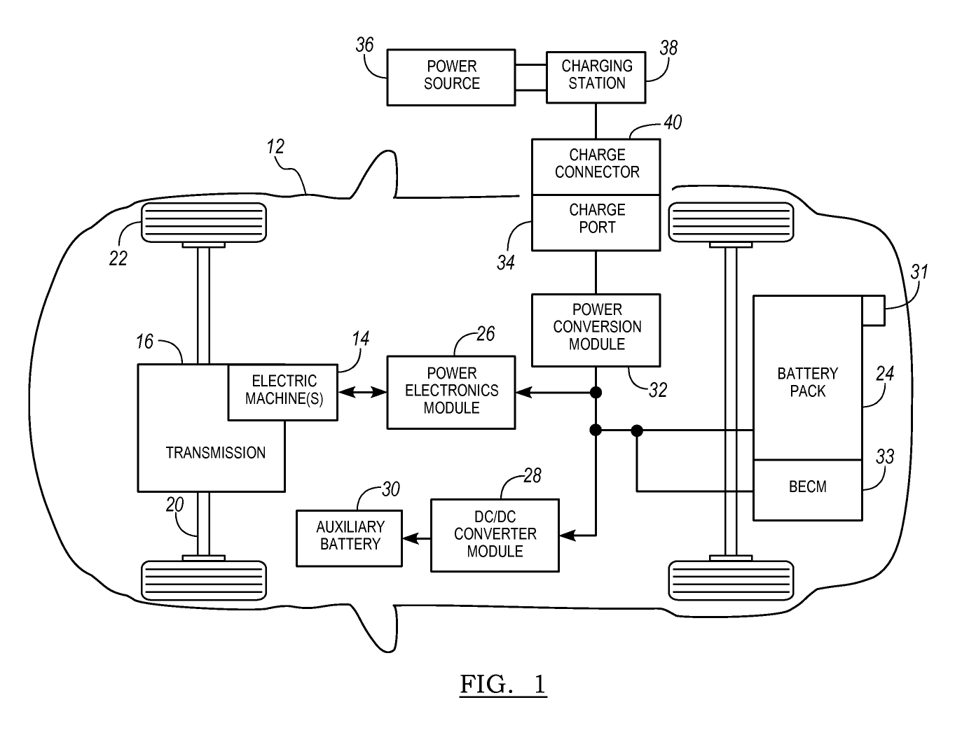

FIG. 1 depicts a schematic of a typical battery-electric vehicle (BEV). Certain embodiments, however, may also be implemented within the context of plug-in hybrid-electric vehicles. The vehicle 12 includes one or more electric machines 14 mechanically connected to a transmission 16. The electric machines 14 may be capable of operating as a motor or a generator. If the vehicle is a hybrid-electric vehicle, the transmission 16 is mechanically connected to an engine. The transmission 16 is mechanically connected to the wheels 22 via a drive shaft 20. The electric machines 14 can provide propulsion and deceleration capability. The electric machines 14 also act as generators and can provide fuel economy benefits by recovering energy through regenerative braking

A fraction battery or battery pack 24 stores energy that can be used by the electric machines 14. The fraction battery 24 typically provides a high voltage direct current (DC) output from one or more battery cell arrays, sometimes referred to as battery cell stacks, within the traction battery 24. The battery cell arrays may include one or more battery cells.

The battery cells (such as a prismatic, pouch, cylindrical, or any other type of cell), convert stored chemical energy to electrical energy. The cells may include a housing, a positive electrode (cathode) and a negative electrode (anode). An electrolyte may allow ions to move between the anode and cathode during discharge, and then return during recharge. Terminals may allow current to flow out of the cell for use by the vehicle.

Different battery pack configurations are available to address individual vehicle variables including packaging constraints and power requirements. The battery cells may be thermally regulated with a thermal management system. Examples of thermal management systems include air cooling systems, liquid cooling systems, and a combination of air and liquid systems.

The traction battery 24 may be electrically connected to one or more power electronics modules 26 through one or more contactors (not shown). The one or more contactors isolate the traction battery 24 from other components when opened, and connect the traction battery 24 to other components when closed. The power electronics module 26 may be electrically connected to the electric machines 14 and may provide the ability to bi-directionally transfer electrical energy between the traction battery 24 and the electric machines 14. For example, a typical traction battery 24 may provide a DC voltage while the electric machines 14 may require a three-phase alternating current (AC) voltage to function. The power electronics module 26 may convert the DC voltage to a three-phase AC voltage as required by the electric machines 14. In a regenerative mode, the power electronics module 26 may convert the three-phase AC voltage from the electric machines 14 acting as generators to the DC voltage required by the traction battery 24.

In addition to providing energy for propulsion, the traction battery 24 may provide energy for other vehicle electrical systems. A typical system may include a DC/DC converter module 28 that converts the high voltage DC output of the traction battery 24 to a low voltage DC supply that is compatible with other vehicle components. Other high-voltage loads, such as air conditioning compressors and electric heaters, may be connected directly to the high-voltage supply without the use of a DC/DC converter module 28. In a typical vehicle, the low-voltage systems are electrically connected to the DC/DC converter and an auxiliary battery 30 (e.g., a 12 volt battery).

A battery energy control module (BECM) 33 may be in communication with the traction battery 24. The BECM 33 may act as a controller for the traction battery 24 and may also include an electronic monitoring system that manages temperature and charge state of each of the battery cells. The traction battery 24 may have a temperature sensor 31 such as a thermistor or other temperature gauge. The temperature sensor 31 may be in communication with the BECM 33 to provide temperature data regarding the traction battery 24.

The vehicle 12 may be recharged by an external power source 36. The external power source 36 may be a connection to an electrical outlet connected to the power grid or may be a local power source (e.g. solar power). The external power source 36 is electrically connected to a vehicle charging station 38. The charger 38 may provide circuitry and controls to regulate and manage the transfer of electrical energy between the power source 36 and the vehicle 12. The external power source 36 may provide DC or AC electric power to the charger 38. The charger 38 may have a charge connector 40 for plugging into a charge port 34 of the vehicle 12. The charge port 34 may be any type of port configured to transfer power from the charger 38 to the vehicle 12. The charge port 34 may be electrically connected to a charger or on-board power conversion module 32. The power conversion module 32 may condition the power supplied from the charger 38 to provide the proper voltage and current levels to the traction battery 24. The power conversion module 32 may interface with the charger 38 to coordinate the delivery of power to the vehicle 12. The charger connector 40 may have pins that mate with corresponding recesses of the charge port 34. In other embodiments, the charging station may be an induction charging station. Here, the vehicle may include a receiver that communicates with a transmitter of the charging station to wirelessly receive electric current.

The charging station 38 comes in various embodiments that have different power output capacities. For example, some stations 38 can output between 6 to 10 kilowatts (kW), while others can only output 1 to 2 kW. The power output of a charging station is dependent upon the voltage available and the current capacity of the circuitry.

The various components discussed may have one or more controllers to control and monitor the operation of the components. The controllers may communicate via a serial bus (e.g., Controller Area Network (CAN)) or via dedicated electrical conduits. The controller generally includes any number of microprocessors, ASICs, ICs, memory (e.g., FLASH, ROM, RAM, EPROM and/or EEPROM) and software code to co-act with one another to perform a series of operations. The controller also includes predetermined data, or “look up tables” that are based on calculations and test data, and are stored within the memory. The controller may communicate with other vehicle systems and controllers over one or more wired or wireless vehicle connections using common bus protocols (e.g., CAN and LIN). Used herein, a reference to “a controller” refers to one or more controllers.

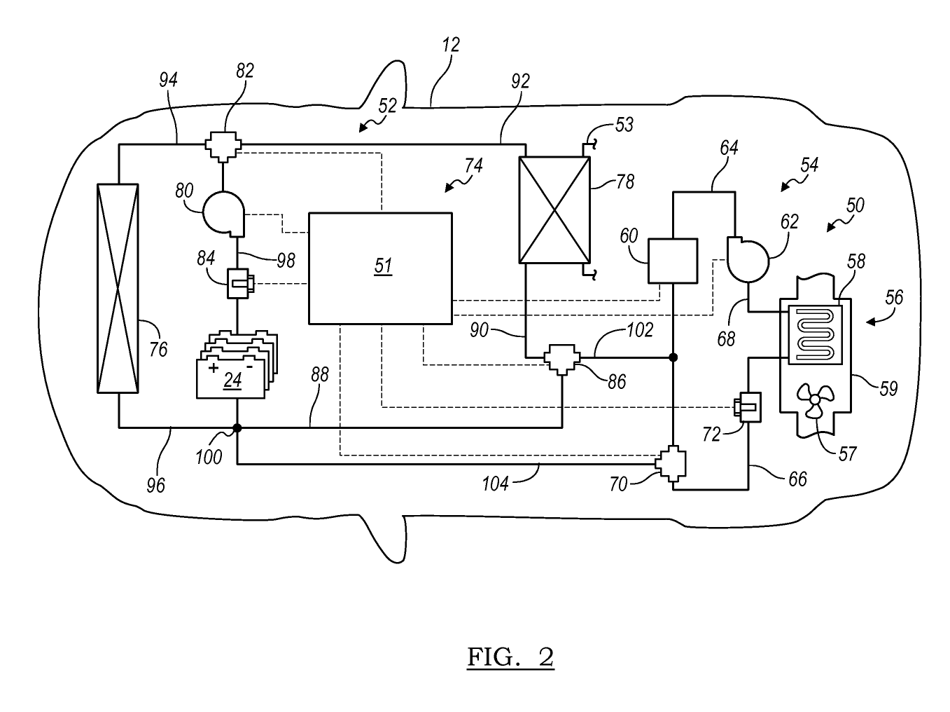

The traction battery 24, the passenger cabin, and other vehicle components are thermally regulated with one or more thermal management systems. Example thermal management systems are shown in the Figures and described below. Referring to FIG. 2, the vehicle 12 includes a cabin and an engine compartment that are separated by a bulkhead. Portions of the various thermal management systems may be located with the engine compartment and/or the cabin. The vehicle 12 includes a climate control system 50 having a refrigerant subsystem 53 (mostly not shown), a cabin-heating subsystem or cabin loop 54, and a ventilation subsystem 56. The ventilation subsystem 56 may be disposed within the dash of the cabin. The ventilation subsystem 56 includes a housing 59 having an air-inlet side and air-outlet side. The outlet side is connected to ducts that distribute exiting air into the cabin. A blower motor drives a fan (or cabin blower) 57 for circulating air in the ventilation system 56. The vehicle 12 may also include a battery thermal management system 52 for regulating the temperature of the traction battery 24. The battery thermal management system 52 and the climate control system 50 may be connected in fluid communication to form a single thermal circuit. In some embodiments, the battery thermal management system 52 and the climate control system 50 are selectively connected in fluid communication to form a single thermal circuit during certain operating conditions, and are separate thermal circuits during other operating conditions.

The cabin loop 54 includes a heater core 58, an electric heater 60, a pump 62, a first valve 70, a sensor 72, and conduit forming a closed loop for circulating coolant, such as an ethylene glycol mixture. For example, coolant may be circulated from the pump 62 to the electric heater 60 via conduit 64. The electric heater 60 is connected to the heater core 58 via conduit 66. The heater core 58 is connected to pump 62 via conduit 68. The first valve 70 and the sensor 72 may be disposed on conduit 66. Alternately, conduit 66 may be separate conduits with one conduit connecting the heater 60 and the first valve 70, and another conduit connecting the first valve 70 and the heater core 58. The valve 70 may be a solenoid valve that is electronically controlled by the controller 51. Dashed lines illustrate electrical connections between the controller 51 and the various components. Solid lines illustrate coolant conduits.

The cabin loop 54 is configured to circulate heated coolant to the heater core 58 during at least a heating mode of the climate control system 50. The heater core 58 is disposed within the heating, ventilation, and air-conditioning (HVAC) housing 59. The electric heater 60 may be electrically connected to the traction battery 24, which provides power to the electric heater 60. The electric heater 60 may include a resistance heating element that converts electrical energy into heat energy in order to heat the coolant circulating through the heater 60. The fan 57 disposed within the HVAC housing 59 circulates air across the heater core 58 to extract heat from the coolant and blows the heated air into the cabin to heat the cabin. The sensor 72 measures a temperature of the coolant circulating in conduit 66 and sends a signal to the controller 51 that is indicative of the coolant temperature. Based on this temperature signal the controller may increase or decrease a heating output of the heater 60.

The battery thermal management system 52 may operate in a plurality of different modes, such as battery heating mode or battery cooling mode. The battery thermal management system 52 includes a battery coolant loop 74 that regulates the temperature of the traction battery 24. The battery loop 74 includes a battery radiator 76, a chiller 78, a pump 80, a second valve 82, a sensor 84, a third valve 86, and conduit arranged to circulate a coolant—such as an ethylene glycol mixture—between the various components of the battery cooling loop 74. For example, the pump 80 circulates coolant to the battery pack 24 via conduit 98. The sensor 84 may be disposed on conduit 98 up stream of the battery pack 24. The sensor 84 senses the temperature of the coolant and sends a signal indicative of the battery coolant temperature to the controller 51. Coolant exiting the battery pack 24 circulates to a four-way connector 100, and either circulates to the battery radiator 76 or to the chiller 78 depending upon the positioning of the valves 82, 86. The battery coolant loop 74 may cool the traction battery 24 via either the battery radiator 76 or the chiller 78. The chiller 78 dissipates heat by transferring thermal energy from coolant within the battery loop 74 to the refrigerant system 53. The battery radiator 76 is disposed behind a front grille of the vehicle and dissipates heat to the outside air. An inlet port of the battery radiator 76 is connected to the four-way connector 100 via conduit 96. An outlet port of the battery radiator 76 is connected to an inlet of the second valve 82 via conduit 94. An outlet of the second valve 82 is connected back to the pump 80 via conduit 98. Another inlet of the second valve 82 is connected to an outlet port of the chiller 78 via conduit 92. The second valve 82 may be similar to the first valve 70. The inlet port of the chiller 78 is connected to the third valve 86 via conduit 90. The third valve 86 may be similar to the first valve 70. The third valve 86 is connected to the four-way connector 100 via conduit 88. The third valve 86 may be connected to conduit 66 of the cabin loop 54 via a first interconnecting conduit 102. The four-way connector 100 may be connected to the first valve 70 of the cabin loop 54 via a second interconnecting conduit 104.

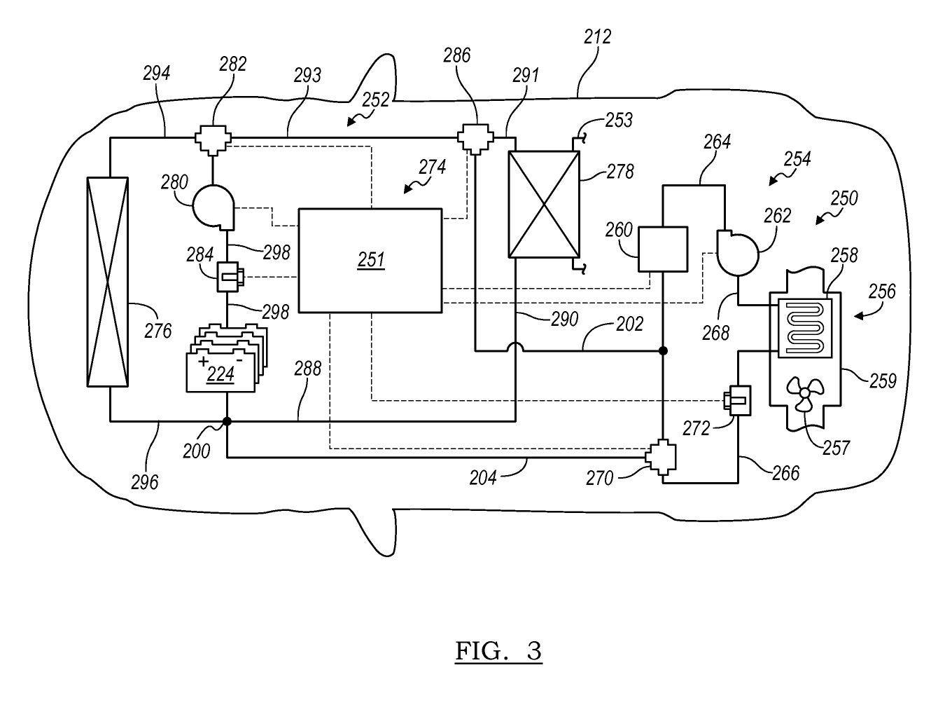

FIG. 3 illustrates a vehicle 212 that is very similar to vehicle 12 except the valving and conduit are arranged to enable bypassing of the chiller 278 during certain operating modes. The layout of the cabin loop 254 may be similar to that of FIG. 2 and will not be described here again.

The battery loop 274 includes a battery radiator 276, a chiller 278, a pump 280, a second valve 282, a sensor 284, a third valve 286, and conduit arranged to circulate a coolant—such as an ethylene glycol mixture—between the various components of the battery cooling loop 274. For example, the pump 280 circulates coolant to the battery pack 224 via conduit 298. The sensor 284 may be disposed on conduit 298 upstream of the battery pack 224. Coolant exiting the battery pack 224 circulates to a four-way connector 200, and either circulates to the battery radiator 276 or the chiller 278 depending upon the positioning of the valves 270, 282, 286. The battery coolant loop 274 may cool the traction battery 224 via either the battery radiator 276 or via the chiller 278. The chiller 278 dissipates heat by transferring thermal energy from coolant within the battery loop 274 to the refrigerant system 253. The battery radiator 276 is disposed behind a front grille of the vehicle and dissipates heat to the outside air. An inlet port of the battery radiator 276 is connected to the four-way connector 200 via conduit 296. An outlet port of the battery radiator 276 is connected to an inlet of the second valve 282 via conduit 294. An outlet of the second valve 282 is connected back to the pump 280 via conduit 298. Another inlet of the second valve 282 is connected to an outlet port of the third valve 286 via conduit 293. An outlet port of the third valve 286 is connected to an outlet port of the chiller 278 via conduit 291. The inlet port of the chiller 278 is connected to the connector 200 via conduit 290. The third valve 286 may be connected to conduit 266 of the cabin loop 254 via a first interconnecting conduit 202. The four-way connector 200 may be connected to the first valve 270 of the cabin loop 254 via a second interconnecting conduit 204. FIGS. 2 and 3 are merely two examples: the present disclosure contemplates others.

The range of an electric vehicle is at least partially dependent upon the amount of stored energy in the battery pack. Current battery technologies are limited in the amount of energy that can be stored within the battery pack. Vehicle range may be extended by using more battery energy for a vehicle propulsion and less battery energy for ancillary operations, such as heating the battery or cabin. One way to increase vehicle range is to precondition the vehicle prior to departure. During precondition, the vehicle is electrically connected with the charging station and wall power is available. Used herein, wall power refers to any external electrical power source, such as the power grid or a charging station. During precondition, the wall power is used to power the vehicle systems instead of the battery. The vehicle may be preconditioned by heating the battery, the cabin, or both via the wall power prior to departure. The controller 51 may receive input from a user stating the next departure time (or next planed usage time) or may estimate a departure time based on customer habits. Based on this departure time, the controller will begin preconditioning one or more of the vehicle systems at an appropriate time prior to departure. The preconditioning time varies according to the systems being preconditioned and the ambient conditions. For example, the battery requires a longer preconditioning time than the passenger cabin. As such, the controller will begin heating the battery prior to the cabin in the event both systems are requested to be heated. Also, the battery may require a longer preconditioning time when the air temperature is colder.

Preconditioning may be broken up into several different modes, such as battery heating mode, battery cooling mode, cabin cooling mode, and cabin heating mode. These modes may operate simultaneously or may operate one at a time depending upon vehicle conditions, time to next planned usage, and available wall power. Some of these modes will now be described below in detail.

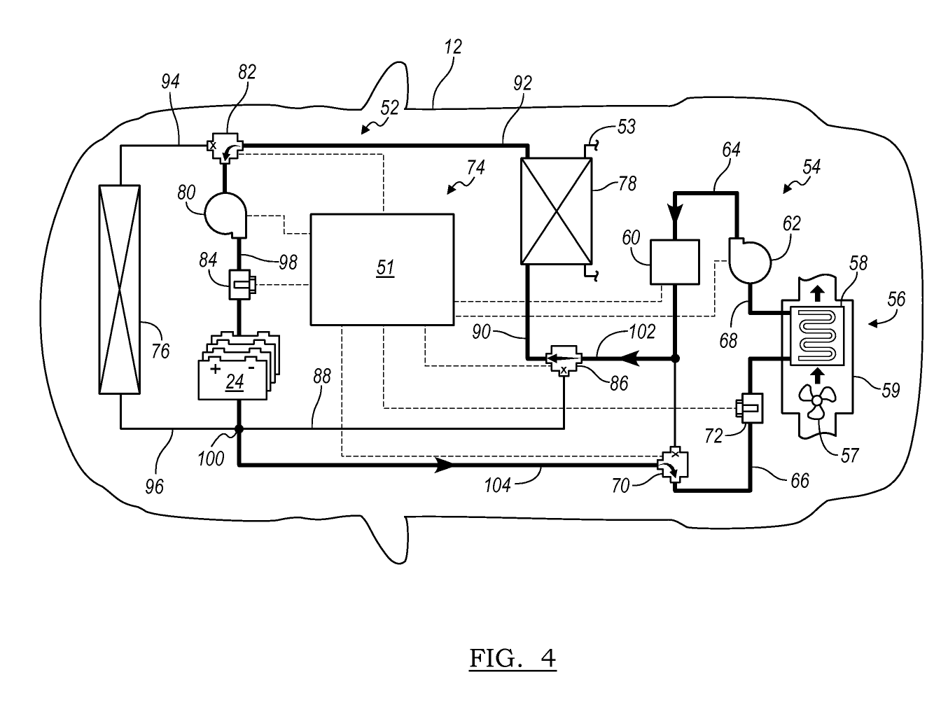

Referring to FIG. 4, an example battery heating and cabin heating mode is shown. Bold lines signify active conduits. Heated coolant is circulated to the traction battery 24 and the heater core 58 to raise a temperature of the battery cells and the cabin to a desired temperature. Rather than having a pair of dedicated heaters (i.e. one for the battery loop and one for the cabin loop), the vehicle 12 may have a single heater (e.g. heater 60). In the illustrated embodiment, the valves are actuated such that the cabin loop 54 and the battery loop 74 are interconnected to form a single thermal circuit. Thus, coolant heated by the heater 60 can be circulated to the battery loop 74 via the conduits as desired.

The controller 51 sends signals to the valves 70, 82, and 86 and in response the valves actuate into a desired position. For example, valve 70 may be actuated such that coolant exiting the heater 60 is circulated to the battery loop 74 via interconnecting conduit 102. Valve 86 is actuated such that coolant circulates to conduit 90 and not to conduit 88. Valve 82 is actuated such that coolant circulates to conduit 98 and not to conduit 94. The controller 51 may also send signals to the pump 62 and the pump 80 instructing the pumps to begin circulating coolant through the thermal circuit. The coolant is circulated through the heater 60 (where the coolant absorbs heat) and to the battery pack 24 via interconnecting conduit 102 and conduits 90, 92, and 98. The cells within the battery pack 24 absorb a portion of the thermal energy in the coolant as the coolant passes through the battery pack 24. The coolant then circulates back to the cabin loop 54 via interconnecting conduit 104. Valve 70 is actuated to direct coolant to the heater core 58. The fan 57 circulates air across the heater core 58 and blows warm air into the cabin. The coolant exiting the heater core 58 is then recirculated back to the pump 62 via conduit 68. During heating mode the controller monitors the various sensors (e.g. 72 and 84) and may adjusts a heating output of the heater 60 as desired. During a battery-only heating mode, the valves and pumps may be actuated the same as above, but the fan 57 is turned OFF. While this preconditioning mode is being described in conjunction with the embodiment shown in FIG. 2, this mode is equally applicable to the vehicle of FIG. 3.

The valves of the thermal management system 52 and the climate control system 50 may be actuated such that the cabin loop 54 and the battery loop 74 operate as separate thermal circuits. For example, this may occur during preconditioning when only the cabin is being heated.

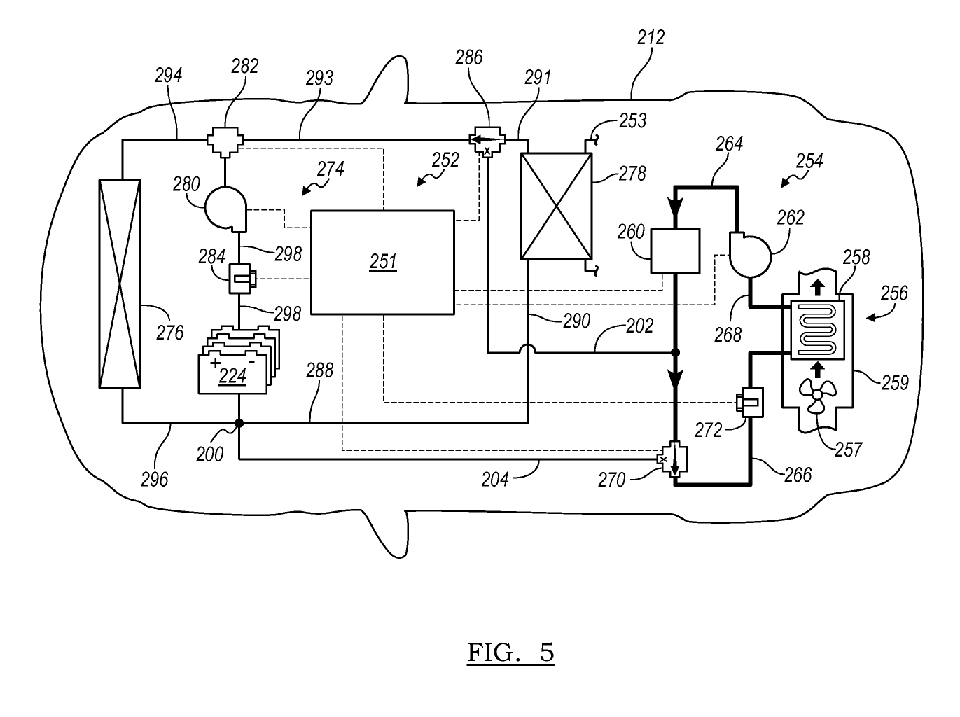

FIG. 5 illustrates the cabin of the vehicle 212 being preconditioned. In this example, only the cabin is being heated and not the battery 224. The valve 270 may be actuated to prevent coolant in interconnecting conduit 204 from circulating into conduit 266, and valve 286 may be actuated to prevent coolant in interconnecting conduit 202 from entering into conduit 293. In a cabin only heating mode, the pump 262 is energized by the controller 251 in order to circulate coolant through the heater 260 and into the valve 270. The valve 270 is actuated to send coolant to the heater core 258 via conduit 266. The fan 257 is actuated to blow air across the heater core in order to heat the cabin. The controller 251 is in electronic communication with sensor 272, which monitors a temperature of the coolant. Based on the coolant temperature, the controller may increase or decrease the heat output of the heater 260 as desired. While this heating mode is being described in conjunction with the embodiment shown in FIG. 3, this heating mode is equally applicable to the vehicle according to FIG. 2. During a cabin only heating mode, the thermal management system 252 may be inactive with the pump 280 de-energized, or may be active.

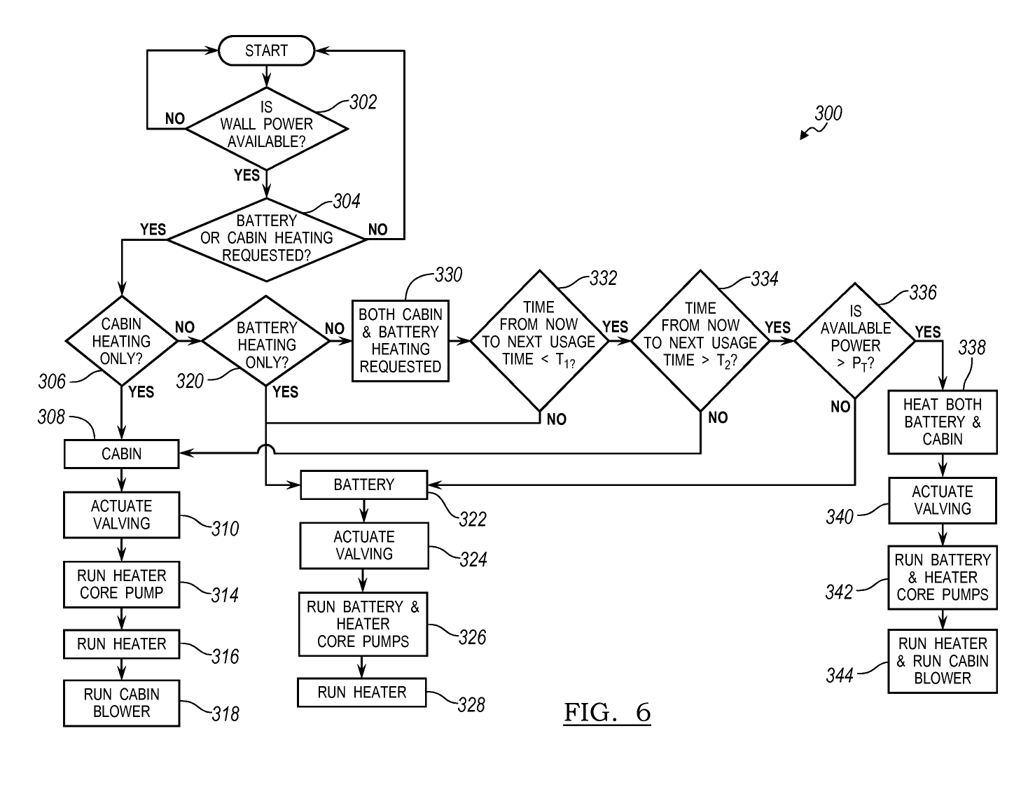

Because the charging station has limited power output and the heater has limited heating output, the controller may have to prioritize and choose which components to heat, and which components not to heat, based on certain conditions. Referring to FIG. 6, control strategy 300 describes one embodiment for preconditioning the vehicle. The control strategy 300 includes logic for selectively heating the battery, the cabin, or both based on a time of next planned usage. The control strategy 300 may be implemented by one or more controllers (e.g. Controller 51) of the vehicle. The control strategy 300 starts by determining if wall power is available at operation 302. If wall power is not available, the vehicle cannot be preconditioned and control loops back to the start. If wall power is available, the controller determines whether or not battery or cabin heating is requested at operation 304. Battery heating may be requested if the controller determines that the battery temperature is below a threshold temperature and if a time to next planned usage is less than a threshold time. For example, the battery may be heated if the temperature is below −5° Celsius (C) and the next planned usage is less than 90 minutes. The temperature and time that triggers a request to heat the battery is calibratable. For example, the colder the battery the earlier the system will request battery heating. Cabin heating may be requested by user preference. For example, the controller may receive inputs from a user indicating a desire cabin temperature. If the controller determines that the cabin is below the desired temperature, cabin heating is requested at an appropriate time prior to the next planned usage (e.g. 15 min.). At operation 306 the controller determines if only cabin heating is requested.

If only cabin heating is currently requested, control passes to operation 308 and the cabin is heated according to the following steps. The vehicle, for example vehicle 212, may enter a cabin only heating mode by actuating the valves 270 and 286 into certain positions. For example, at operation 310 the controller may send a signal to the valves 270, 286 instructing the valves to the position shown in FIG. 5. Once the valves have been actuated into the proper position, control passes to operation 314 and the heater core pump (e.g. pump to 262) is energized and the coolant is circulated through the thermal circuit. At operation 316 the heater 260 is energized to heat the coolant. A heat output of the heater may be increased or decreased based on signals sent from the various temperature sensors—which indicate the coolant temperature at various positions along the thermal circuit—in order to heat the coolant to a desired temperature. At operation 318, the cabin blower fan is activated. The duty cycle of the fan may be determined based on a desired temperature of the cabin, the ambient air temperature, and coolant temperature. The cabin may receive heat until a temperature of the cabin meets or exceeds a desired temperature or until operating conditions change—at which point, the system will may longer request cabin heating.

If at operation 304 it is determined that the cabin is not requesting heat, or that the battery is requesting heat, control passes to operation 320. If at operation 320 only the battery is requesting heat, control passes to operation 322 and the battery is heated. The vehicle, for example vehicle 12, may enter a battery only heating mode by actuating the valves 72, 82, and 86 into certain positions. For example, at operation 324, the controller may send a signal to the valves 70, 82, and 86 instructing the valves to the position shown in FIG. 4. Once the valves are actuated into the proper position, control passes to operation 326 and the battery and heater core pumps are energized and coolant is circulated through the thermal circuit. At operation 328 the heater is energized to heat the coolant to a desired battery coolant temperature. A heat output of the heater may be increased or decreased based on signals sent from the various temperature sensors, which indicate the coolant temperature at various positions along the thermal circuit.

If it is determined that the cabin and the battery are requesting heating, control passes to operation 330. At operation 332 the controller determines if the time from now to the next planned usage is less than a first time threshold (T₁). T₁ may be a time that is longer than a time required to heat the cabin. For example, T₁ may be in a range between 90 and 30 minutes inclusive. If the time to the next planned usage is greater than T₁, then control passes to operation 322 and only the battery is preconditioned because preconditioning of the cabin need not occur yet. If at operation 322 the time to the next planned usage is less than T₁, then control passes to operation 334. At operation 334 the controller determines if the time from now to the next planned usage is greater than a second time threshold (T₂). For example, T₂ may be in a range between 2 to 20 minutes inclusive. T₂ may represent an optimal time to begin heating the cabin. Both T₁ and T₂ are calibrated values that may be a function of the ambient air temperature, the magnitude of the wall power, and the size of the heat sink. The controller may include one or more look up tables having a plurality of different T₁ and T₂ values depending upon those parameters.

If the time to the next usage is not greater than T₂, control passes to operation 308 and only the cabin is preconditioned because the time to next planned usage is too soon to have any effect on the battery. If the time the next usage is greater than T₂, control passes operation 336. When the time to next planned usage is less than T₁ and greater than T₂, both the cabin and the battery are a candidate for heating if a sufficient amount of wall power is available. At operation 336 the controller determines if the available wall power (e.g. power supplied by the charging station) is above a power threshold (Pₜ), which represents a minimal amount of power required to heat both the battery and the cabin. The power threshold may based, at least in part on, temperature of the ambient air. For example, Pₜ may be 2 kW. If the available wall power is below Pₜ, then insufficient power is available to heat both the cabin and the battery. Thus, one must be prioritized over the other. In control logic 300, the battery is prioritized over the cabin. As such, if insufficient power is determined at operation 336, control passes to operation 322 and only the battery is heated. But, if sufficient wall power is available, control passes to operation 338 and both the cabin and the battery are preconditioned. At operation 340 the valves are actuated such that both the battery and the cabin are heated. For example, the valves 70, 82, and 86 are actuated such that the battery cooling loop 74 and the cabin cooling loop 54 form a single thermal circuit as is shown in FIG. 4 and described above. When the battery loop 74 and the cooling loop 54 are combined, heated coolant can be circulated to both the battery 24 and the heater core 58 so that both components may be heated. At operation 342 the battery and the heater core pumps are energized to circulate coolant through the thermal circuit. In some embodiments, only one of the pumps may be run. At operation 344 the heater is energized to output heat into the coolant and the cabin blower is energized once the coolant temperature exceeds a threshold value, such as 40 degrees C. The sensors 72, 84 send signals to the controller 51 indicating a coolant temperature. Based on these signals, the controller can modify heat output of the heater 60. Control strategy 300 may be cycled periodically, such as every 100 milliseconds.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
a fraction battery;
a cabin; and
a controller programmed to, in response to a request to heat both the battery and the cabin, and a time to next planned usage of the vehicle exceeding a first threshold time, heat the battery and delay heating the cabin at least until the time to next planned usage is less than the first threshold time.

2. The vehicle of claim 1 wherein the controller is further programmed to, in response to the time to next planned usage being less than the first threshold time and exceeding a second threshold time, heat both the battery and the cabin, wherein the first threshold time is greater than the second threshold time.

3. The vehicle of claim 2 wherein the controller is further programmed to, in response to a magnitude of power available from a charging station being less than a threshold power, heat the battery and not the cabin.

4. The vehicle of claim 3 wherein the controller is further programmed to, in response to the magnitude exceeding the threshold power, heat the battery and the cabin.

5. The vehicle of claim 2 wherein the controller is further programmed to, in response to the time to next planned usage being less than the second threshold time, heat the cabin and not the battery.

6. The vehicle of claim 1 wherein the controller is further programmed to heat the battery only if a vehicle charge port is receiving current.

7. The vehicle of claim 2 wherein the first threshold time is between 30 to 120 minutes, and the second threshold time is between 2 to 25 minutes.

8. A vehicle comprising:
a battery;
a thermal circuit arranged to circulate coolant through the battery, a heater, a pump and valving; and
a controller programmed to, in response to a request to heat both the battery and a cabin, and a time to next planned usage of the vehicle exceeding a first threshold time, de-energize a cabin blower, energize the pump and the heater, and actuate the valving such that the battery receives heated coolant.

9. The vehicle of claim 8 wherein the thermal circuit is further arranged to circulate coolant through a heater core, wherein the controller is further programmed to, in response to the time to next planned usage being less than the first threshold time and exceeding a second threshold time, actuate the valving such that the battery and the heater core receive heated coolant and energize the cabin blower to heat the cabin, and wherein first threshold time is greater than the second threshold time.

10. The vehicle of claim 9 wherein the controller is further programmed to, in response to a magnitude of power available from a charging station being less than a threshold power, de-energize the cabin blower.

11. The vehicle of claim 10 wherein the controller is further programmed to, in response to the magnitude exceeding the threshold power, actuate the valving to circulate heated coolant to the battery and the heater core, and actuate the cabin blower.

12. The vehicle of claim 9 wherein the controller is further programmed to, in response to the time to next planned usage being less than the second threshold time, actuate the valving such that the heater core receives heated coolant and the battery does not receive heated coolant, and energize the cabin blower to heat the cabin.

13. The vehicle of claim 8 wherein the controller is further programmed to energize the pump and the heater, and actuate the valving only if a vehicle charge port is receiving power from a charging station.

14. The vehicle of claim 8 wherein the thermal circuit further includes a battery loop configured to circulate coolant through the battery and a first valve, and a cabin loop configured to circulate coolant through a heater core, the heater, and a second valve, wherein a first conduit fluidly connects between the first valve and the cabin loop and a second conduit fluidly connects between the second valve and the battery loop, and wherein the controller is further programmed to actuate the first and second valves such that heated coolant is circulated to both the battery and the heater core if the time to next planned usage is less than a first threshold time and greater than a second threshold time.

15. A method of preconditioning a vehicle including a cabin and a traction battery configured to receive power from a charging station, the method comprising:
receiving a request to heat both the battery and the cabin;
heating the battery while the vehicle is receiving power from the charging station in response to a time to next planned usage of the vehicle being greater than a first threshold time; and
delaying heating of the cabin at least until the time to next planned usage is less than the first threshold time.

16. The method of claim 15 further comprising heating both the battery and cabin in response to the time to next planned usage being less than the first threshold time and exceeding a second threshold time.

17. The method of claim 16 further comprising heating the battery and not the cabin in response to a magnitude of power available from the charging station being less than a threshold power.

18. The method of claim 17 further comprising heating both the battery and the cabin in response to the magnitude exceeding the threshold power.

19. The method of claim 16 further comprising heating the cabin and not the battery in response to the time to next planned usage being less than the second threshold time.

20. The method of claim 16 wherein the first threshold time is between 30 to 120 minutes, and the second threshold time is between 2 to 25 minutes.
